(19) United States
(12) Patent Application Publication
(10) Pub. No.: US 2005/0090374 A1
(43) Pub. Date: Apr. 28, 2005

(54) Multi-chamber flat tube

(76) Inventors: Werner Helms, Esslingen (DE); Wolfgang Kramer, Weinstadt (DE); Florian Moldovan, Stuttgart (DE)

Correspondence Address: FOLEY AND LARDNER;SUITE 500, 3000 K STREET NW, WASHINGTON, DC, 20007, US

(21) Appl. No.: 10/501,812

(22) PCT Filed: Jan. 16, 2003
(86) PCT No.: PCT/EP03/00404

(30) Foreign Application Priority Data
Jan. 17, 2002 (DE) 102 01 512.0

(51) Int. Cl. B31C 3/00

(52) U.S. Cl. 493/269

(57) ABSTRACT

The invention relates to a multi-chamber tube, produced from a flat sheet (2), welded along the longitudinal surfaces with two planar face surfaces (5, 6), two curved narrow sides (3, 7) and webs (8), folded from the flat strip (2) which divide adjacent (chambers (9, 10) and which are soldered to the opposing tube inner wall (6) and a method for production thereof. According to the invention, the flat strip (2) comprises inward projections (15) in the region of the soldering of the webs (8).

The invention relates to a multi-chamber flat tube which is manufactured from a flat strip and closed by means of a longitudinal seam, according to the preamble of patent claim 1. Such a multi-chamber flat tube has been disclosed by EP-A 0 457 470.

The known flat tube is manufactured from a strip of sheet metal or a flat strip, beads being initially embossed into the flat strip, specifically over its entire width, i.e. in both halves of the flat strip. The beads are then shaped into folded webs with the result that the two limbs of the webs abut closely one against the other. The tube is then folded approximately in the center so that the two strip halves come to bear one against the other, the webs being arranged offset with respect to one another. The abutting longitudinal edges of the two strip halves are then welded to one another by means of a longitudinal seam so that a closed cross section is produced. Finally, the tube, whose strip material is solder plated, is soldered so that the backs of the webs form a soldered connection with the tube wall located opposite. So-called corrugated fins, which are soldered to the flat tubes, are arranged on the outside of the flat tubes.

In a further embodiment in EP-A-0 457 470, the webs are not offset with respect to one another but rather arranged opposite one another, but they extend only over half the tube thickness and abut one another in the center. A disadvantage of this known multi-chamber tube is that tolerances in the web height which are due to fabrication can be compensated only with difficulty, resulting in a situation in which there is either no continuous soldered connection between the web backs and the opposite inner wall side of the tube, or the external dimension of the flat tube exceeds the reference dimension.

In addition, so-called bead tubes are known, for example from DE-A 40 26 988 or DE-A 195 10 283 from the applicant. Although these beads have a certain degree of elasticity when the flat tube is standardized to the reference thickness so that the tolerances due to fabrication can be compensated, the beads on the outside of the tube produce a gap with respect to the soldered-on fins, which results in a break in the transfer of heat.

The object of the present invention is therefore to improve the multi-chamber flat tube of the generic type to the effect that the tolerances which are due to fabrication can easily be compensated, and that a continuous transfer of heat to the soldered-on fin is ensured on the outside of the flat tube. The object of the invention is also to produce a method for manufacturing a flat tube of the generic type, with which method the fabrication tolerances can be compensated and a dimensionally accurate tube can be fabricated.

The means of achieving this object with respect to the multi-chamber flat tube of the generic type results from the characterizing features of patent claim 1.

The arrangement of a plateau-like embossment on the longitudinal face of the tube located opposite a web back produces a sprung and/or deformable abutment in the tube wall on which the web back is supported when the tube is standardized. When there is a slight excess in the dimensioning of the height of the web back, the embossment, which is level before the standardization, can deform outward and thus take up the excess dimension. The height of the embossment with respect to the inside of the tube is selected such that it corresponds to the tolerance in the height of the web. The embossment on the outside, i.e. the longitudinal face of the flat tube, is so small that the later soldering process is not adversely affected by the fin, i.e. a continuous soldered connection between the outside of the flat tubes and the corrugations of the corrugated fins can be produced. The flat tube may have one or more webs which are folded out of one or both longitudinal faces. The longitudinal seam can be welded or soldered.

According to one advantageous development of the invention, the width of the plateau-like embossment corresponds approximately to twice to three times the thickness of the wall of the tube, i.e. the flat strip; the height of the embossment with respect to the inside of the tube is less than half the thickness of the wall of the tube. This ensures that the web back can be impressed into the plateau-like embossment when the tube is standardized, without a bulge being produced on the outside of the longitudinal face of the flat tube.

According to one further advantageous refinement of the invention, the webs are arranged only on one longitudinal face of the flat tube, while only the corresponding embossments are provided on the other face. This permits simpler manufacture, in particular with respect to the position of the longitudinal welding seam.

According to a further advantageous refinement of the invention, a method for manufacturing a multi-chamber flat tube of the generic type is proposed which, on the basis of the initially plateau-like embossment with respect to the web back, permits tolerances in the height of the web back and the thickness of the wall of the tube to be compensated by spring compression of the web back into the embossment, thus ensuring a sealed and secure soldered connection over the entire length of the tube. This is important because the webs have to absorb the compressive forces acting on the tube wall, and have to act as tie rods.

An exemplary embodiment of the invention is illustrated in the drawing and will be described in more detail below. In said drawing:

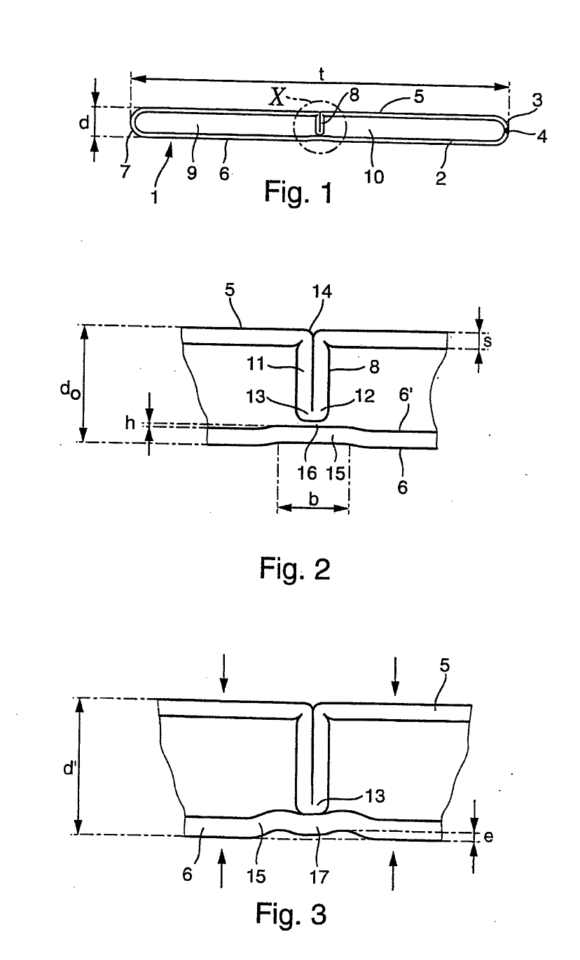

FIG. 1 shows a welded multi-chamber tube with a web,

FIG. 2 shows the detail of the multi-chamber tube according to FIG. 1 before standardization, and

FIG. 3 shows the detail according to FIG. 2 after the standardization.

FIG. 1 shows a cross section through a multi-chamber flat tube 1, which is manufactured from a flat strip 2 of sheet metal and is welded on one narrow face 3 by means of a longitudinal seam 4. The flat tube 1 has a longitudinally extended cross section with two longitudinal faces 5 and 6 and a further rounded narrow face 7. The depth t of the flat tube is approximately 24 mm, and the thickness d is approximately 1.8 mm so that a ratio of depth to thickness t/d≈13 is produced. A web 8, which is manufactured by folding out of the flat strip 2, is arranged approximately in the center of the flat tube 1. It divides the flat tube 1 into two chambers 9 and 10.

FIG. 2 shows the detail X from FIG. 1, i.e. an enlarged detail with the web 8. As already mentioned, the web 8 is manufactured by means of a folding process out of the flat strip material which has a thickness of s≈0.26 mm. The web 8 has two limbs 11, 12 which are connected to one another by means of a web back 13. Both limbs 11, 12 bear closely one against the other, and the two outer bending radii 14 are selected to be as small as possible so that the outer surface of the longitudinal face 5 remains as smooth as possible. A plateau-like elevation 15, which is embossed from the lower longitudinal face 6 of the flat tube 1 toward the inside 6′ of the tube, is arranged opposite the web back 13. This elevation or embossment 15 has a height h with respect to the inside 9, 10 of the tube 1, said height h corresponding to approximately 0.05 mm, i.e. approximately 20% of the thickness s of the wall of the flat strip. The width b of the embossment 15 is approximately 1 mm, i.e. it corresponds approximately to four times the thickness s of the wall.

The illustration in FIG. 2 shows the multi-chamber tube 1 with a thickness do in a state after the web 8 has been folded and the tube has been welded, but before the standardization process with which the precise thickness d of the flat tube 1 is brought about. To this extent, a gap 16 is produced between the web back 13 and the plateau-like elevation 15, i.e. the web back 13 does not rest on the embossment 15. This may come about owing to the manufacturing process because, on the one hand, the height of the web 8 and, on the other hand, the thickness s of the tubular wall are subject to tolerances, and the tube springs back owing to its intrinsic elasticity. However, since the web back is to be soldered later to the opposite face 6 of the flat tube, i.e. the embossment 15, on the one hand an abutment between the web back 13 and plateau 15 must be provided and, on the other hand, a specific final dimension for the thickness d of the tube must be ensured. This is brought about by the so-called standardization process.

FIG. 3 shows the detail of the tube 1, i.e. the detail X after the so-called height standardization, i.e. after the tube has been adjusted to the reference dimension d′ in a set of rollers (not illustrated here). During this height standardization, the two longitudinal faces 5 and 6 are compressed to the dimension d′ by the aforesaid set of rollers, as indicated by the arrows. During this process, the web back 13 has been impressed into the plateau-like elevation 15 and has formed a “dent” 17 there. This “dent” 17 therefore takes up the inaccuracies due to tolerances, after the standardization.

The multi-chamber flat tubes are then soldered to corrugated fins, as is known per se to form a heat exchanger. For this purpose, the strip material 2 for the multi-chamber tubes is solder plated on both sides; on the one hand, a solid connection is thus formed between the web backs 13 and embossment 15 and between the outer sides 5, 6 and the corrugated fins (not illustrated). The web 8 thus functions not only as a dividing wall but also as a tie rod for absorbing internal compressive forces in the tube. The remaining depth e of the embossment 15 or of the “dent” 17 is so small that it does not adversely affect the soldered connection between the corrugated fin and the outside of the tube 1, i.e. the soldering gap which is enlarged somewhat in this region can be readily filled with solder during the soldering process so that an uninterrupted, materially joined connection is formed between the corrugated fin and the outer wall of the tube.

In the exemplary embodiment described above only one web, i.e. one two-chamber tube is illustrated. However, the invention can also be applied to multi-chamber tubes with any desired number of webs or chambers. It is advantageous here if in each case the webs are arranged on one longitudinal face and the plateau-like embossments are arranged on the opposite longitudinal face of the multi-chamber flat tube. The fabrication process and the precise positioning of the longitudinal soldering seam can thus be influenced favorably.

The multi-chamber tube which is described above is preferably used for air-cooled coolant radiators for internal combustion engines for motor vehicles.

1. A multi-chamber tube which is manufactured from a flat strip (2), is closed by means of a longitudinal seam (4) and has two flat longitudinal faces (5, 6) and two curved narrow faces (3, 7) and has at least one web (8) which is folded out of the flat strip (2) and which divides adjacent chambers (9, 10), and is soldered to the inner wall (6) of the tube located opposite, characterized in that, in the region of the soldered connection of the at least one web (8), the flat strip (2) has an embossment (15) which is directed toward the inside (6′) of the tube.

2. The multi-chamber tube as claimed in claim 1, characterized in that the embossment (15) is constructed in the manner of a plateau, specifically with a width b, which corresponds at least to twice the thickness s of the flat strip, and at a height h, which is significantly less than the thickness s of the flat strip.

3. The multi-chamber tube as claimed in claim 2, characterized in that the width b is greater than three times the thickness s of the flat strip, and the height h is less than half the thickness s of the flat strip, i.e. b≧3 s and h≦0.5 s.

4. The multi-chamber tube as claimed in claim 1, characterized in that the thickness of the flat strip is 0.1≦s≦0.5 mm.

5. The multi-chamber tube as claimed in claim 1, characterized in that the tube has a depth t in the region of 20 mm≦t≦60 mm.

6. The multi-chamber tube as claimed in claim 1, characterized in that the tube has a thickness d in the region of 1.5 mm≦d≦2.0 mm.

7. The multi-chamber tube as claimed in claim 1, characterized in that the webs are alternately folded out of the one longitudinal face (5) and out of the opposite longitudinal face (6), and the embossments (15) are also alternately arranged on the longitudinal face which is located opposite a web (8).

8. The multi-chamber tube as claimed in claim 1, characterized in that the webs (8) are folded out of only one longitudinal face (5), and the embossments (15) are arranged on the opposite longitudinal face (6).

9. A method for manufacturing a multi-chamber tube as claimed in claim 1, characterized:
in that a flat strip (2) is made available,
webs (8) are formed from one half of the flat strip by folding, and
the embossments (15) are formed on the other half of the flat strip (2),
in that the flat strip (2) is bent on one narrow face (7) and is moved into abutment and welded on its other narrow face (3),
in that the web backs (13) are moved into abutment with the embossment (15), and the flat tube (1) is standardized to a reference dimension d′, as regards its thickness d, if appropriate by shaping the embossment (15).
